(19) United States
(12) Patent Application Publication
(10) Pub. No.: US 2013/0039594 A1
(43) Pub. Date: Feb. 14, 2013

(54) METHOD AND DEVICE FOR ENCODING DATA FOR RENDERING AT LEAST ONE IMAGE USING COMPUTER GRAPHICS AND CORRESPONDING METHOD AND DEVICE FOR DECODING

(71) Applicants: Quqing Chen, Beijing (CN); Jun Teng, Beijing (CN); Zhibo Chen, Beijing (CN)

(72) Inventors: Quqing Chen, Beijing (CN); Jun Teng, Beijing (CN); Zhibo Chen, Beijing (CN)

(21) Appl. No.: 13/642,147

(22) PCT Filed: Apr. 20, 2010
(86) PCT No.: PCT/CN2010/000537

§ 371 Date: Oct. 19, 2012

(51) Int. Cl. G06K 9/36

(52) U.S. Cl. 382/233; 382/232

(57) ABSTRACT

The invention is made in the field of image codec products. More precisely, the invention relates to encoding and decoding of data for image rendering using computer graphics. A method for decoding data for rendering at least one image using computer graphics is proposed, said method comprising decoding a portion of a bit stream, said portion comprising a syntax element and at least one parameter for a parameter based procedural computer graphics generation method for generating said computer graphics, said syntax element indicating that said portion further comprises said at least one parameter. Further, an apparatus for performing said method is proposed.

### TECHNICAL FIELD

The invention is made in the field of image codec products. More precisely, the invention relates to encoding and decoding of data for image rendering using computer graphics.

### BACKGROUND OF THE INVENTION

Video coding algorithms have been investigated for several decades. Many video coding standards, e.g., MPEG-1/2/4, H.261, H.263, H.b264/AVC, have been developed accordingly. Among these standards, H.264/AVC is the latest one with the best rate-distortion performance for video compression from low-end, e.g., mobile application, to high-end, e.g., High-Definition Television (HDTV) applications.

However, all the existing image/video coding standards are designed to compress pixel maps resulting from capturing natural scenes using capturing devices such as, for instance, CMOS sensors or CCD chips. Image data collected that way will be called natural video (NV) in the following. However in recent years, more and more movies, or other video applications integrate, in addition or alternatively to NV, content which does not result from capturing natural scenes but from rendering of some computer graphics (CG) scenes or special effects. The augmented video content, which consists of both natural video and rendered computer graphics, appears more and more in real applications, such as game, virtual shopping, virtual city for tourists, mobile TV, broadcasting, etc. When 3D natural video application turns mature in the future, this kind of combination can be expected to find more extensive applications in the world.

Therefore, MPEG-4 standard has already started to work on the coding method for the combination of natural video and computer graphics. Originally in 1995, the subgroup SNHC (Synthetic Natural Hybrid Coding, in 2005 the SNHC group of MPEG changed its name into 3DGC (3D Graphics Coding) group) was set up, and it developed the synthetic coding tools in MPEG-4 part 2: visual. The synthetic visual tools include Face and Body Animation (FBA), 2D and 3D mesh coding, and view-dependent scalability. In a nutshell, MPEG-4 SNHC combines graphics, animation, compression, and streaming capabilities in a framework that allows for integration with (natural) audio and video.

In MPEG-4 part 11, BIFS (Binary Format for Scene Description) was defined with generic graphic tools such as interpolator compression. The BIFS specification has been designed to allow for the efficient representation of dynamic and interactive presentations, comprising 2D & 3D graphics, images, text and audiovisual material. The representation of such a presentation includes the description of the spatial and temporal organization of the different scene components as well as user-interaction and animations.

In MPEG-4, every object is tightly coupled with a stream: such binding is made by the means of the Object Descriptor Framework which links an object to an actual stream. This design seems obvious for video objects that rely on a compressed video stream. It has been pushed a bit further: the scene description and the description of object descriptors are themselves streams. In other words, the presentation itself is a stream which updates the scene graph and relies on a dynamic set of descriptors, which allow referencing the actual media streams.

U.S. Pat. No. 6,072,832 describes an audio/video/computer graphics synchronous reproducing/synthesizing system and method. A video signal and computer graphics data are compressed and multiplexed and a rendering engine receives the video signal, the computer graphics data and viewpoint movement data and outputs a synthesized image of the video signal and the computer graphics data.

### SUMMARY OF THE INVENTION

This invention addresses the problem how to efficiently compress an emerging kind of video content which contains both natural video (NV) and rendered computer graphics (CG). Particularly for procedural generated CG content, the invention proposes adapting traditional video coding scheme such that advantage can be taken from the procedural techniques therein.

Therefore, a method for decoding data for rendering at least one image using computer graphics according to claim 1 and a method for encoding data for rendering at least one image using computer graphics according to claim 3 are proposed.

Said encoding method comprises the step of encoding, into a portion of the bit stream, a syntax element and at least one parameter for a parameter based procedural computer graphics generation method for generating said computer graphics, said syntax element indicating that said portion further comprises said at least one parameter.

In an embodiment, said encoding method further comprises the step of encoding a further syntax element and coefficient information into a different portion of the bit stream. In a corresponding embodiment of the decoding method, said decoding method further comprises the step of decoding the further syntax element and coefficient information comprised in the different portion of the bit stream. The coefficient information is for determining an invertible transform of at least one pixel block to-be-used for rendering of the at least one image and said further syntax element indicates that said different portion further comprises said coefficient information.

In a further embodiment of the encoding method, said computer graphics is used for rendering terrain in said at least one image and said at least one parameter is extracted from real terrain data.

The features of further advantageous embodiments of the encoding method or the decoding method are specified in the dependent claims.

The invention further proposes an apparatus for performing one of the methods proposed in the method claims.

A storage medium carrying a bit stream resultant from one of the proposed encoding methods is proposed by the invention, too.

Thus, the invention proposes a new coding method for combined spectral transform encoded content and procedural generated content. In an embodiment, this invention focuses on procedural generated terrain coding. The terrain can be encoded by only a few parameters so that great compression ratio is achieved. Moreover, seamless integration into traditional video coding is achieved by the syntax element.

### BRIEF DESCRIPTION OF THE DRAWINGS

Exemplary embodiments of the invention are illustrated in the drawings and are explained in more detail in the following description. The exemplary embodiments are explained only for elucidating the invention, but not limiting the invention's disclosure, scope or spirit defined in the claims.

In the figures:

FIG. 1a depicts exemplary incoherent noise;

FIG. 1b depicts exemplary coherent noise;

FIG. 2a depicts exemplary Perlin value noise;

FIG. 2b depicts exemplary Perlin gradient noise;

FIG. 3 depicts exemplary levels of detail terrain modelling and rendering; and

FIG. 4 depicts exemplary camera parameters.

### EXEMPLARY EMBODIMENTS OF THE INVENTION

The invention may be realized on any electronic device comprising a processing device correspondingly adapted. For instance, the invention may be realized in a set-top box, television, a DVD- and/or BD-player, a mobile phone, a personal computer, a digital still camera, a digital video camera, an mp3-player, a navigation system or a car audio system.

The invention refers to parameter based procedural computer graphics generation methods.

The term procedural refers to the process that computes a particular function. Fractals, which are an example of procedural generation, express this concept, around which a whole body of mathematics—fractal geometry—has evolved. Commonplace procedural content includes textures and meshes. Procedural techniques have been used within computer graphics to create naturally appearing 2D or 3D textures such as marble, wood, skin or bark, simulate special effects and generate complex natural models such as trees, plant species, particle systems, waterfalls, skies or mountains. Even the natural physical movements of assets can be generated using parameter based procedural computer graphics generation methods. Biggest advantage of procedural techniques is that it can generate natural scenes with only a few parameters so that a huge compression ratio can be achieved. In “A Survey of Procedural Techniques for City Generation”, Institute of Technology Blanchardstown Journal, 14:87-130, Kelly, G. and McCabe, H. provide an overview of several procedural techniques including fractals, L-systems, Perlin noise, tiling systems and cellular basis systems.

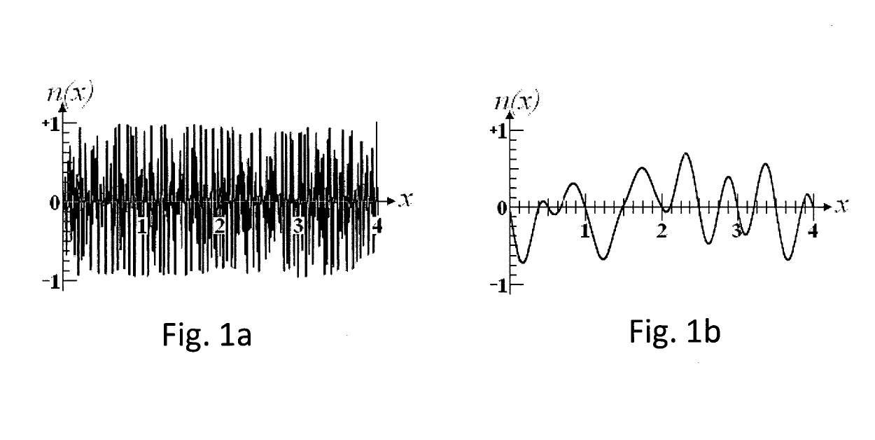

Perlin noise is a type of smooth pseudorandom noise, also called coherent noise an example of which being depicted in FIG. 1b. For such noise, same input always results in same output and small change of input results in small change of output, which makes the noise function static and smooth. Only large change of input results in random change of output, which makes the noise function random and non-repeated.

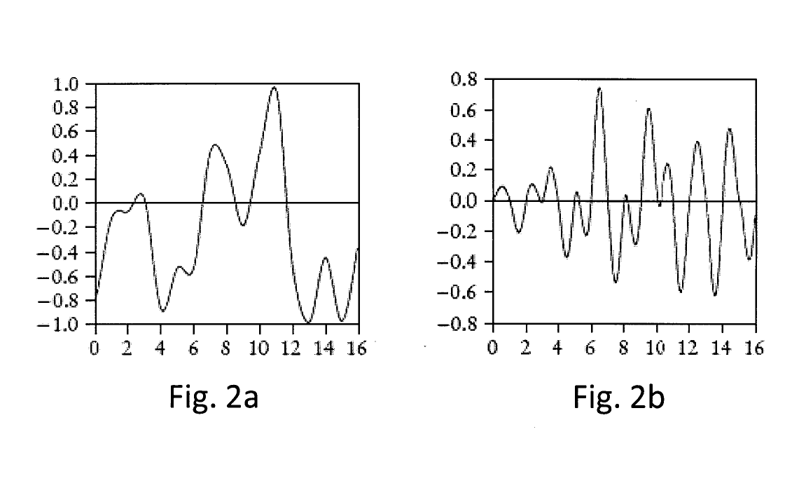

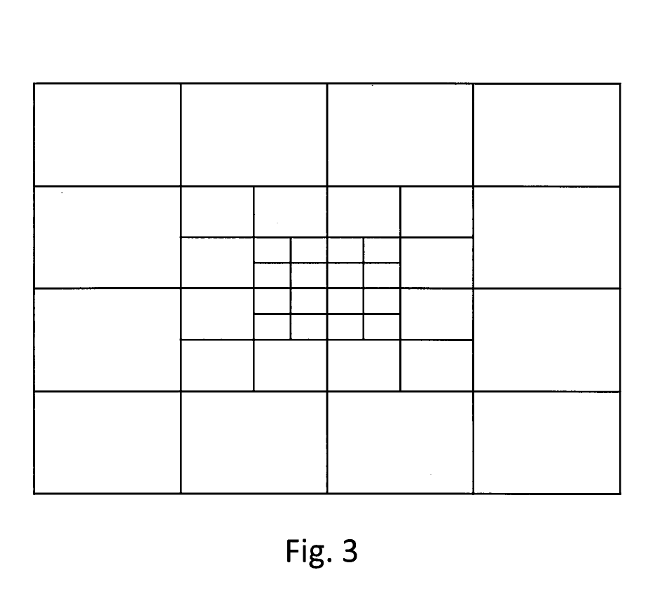

The simplest Perlin noise is called value noise exemplarily depicted in FIG. 2a, a pseudorandom value is created at each integer lattice point, and then the noise value at in-between position is evaluated by smooth interpolation of noise values at adjacent lattice points. Gradient noise exemplarily depicted in FIG. 2b is an improved Perlin noise function, a pseudorandom gradient vector is defined at each integer lattice point, and the noise value at each integer point is set as zero, the noise value at in-between position is evaluated from gradient vectors at adjacent lattice points. Perlin noise makes use of a permutation table. Perlin noise is described by Ken Perlin in: “An image synthesizer”, Siggraph, 1985, pp. 287-296.

For synthesis of terrain, for instance, random spectra synthesis can be used where Perlin noise functions of different frequencies are combined for modeling different levels of details of the terrain. A base frequency level of detail represents the overall fluctuation of the terrain; while at least one higher frequency level of detail represents the detail in terrain geometry. The series of Perlin noise functions are then composed to generate a terrain height map. Random spectra synthesis is triggered by the base frequency, and by the number of frequency levels. The frequency levels are octaves, commonly. Random spectra synthesis of terrain is further triggered by an average terrain height, a height weight and a height weight gain for each frequency level and by lacunarity, a parameter for calculation of height and frequency weights in each frequency level.

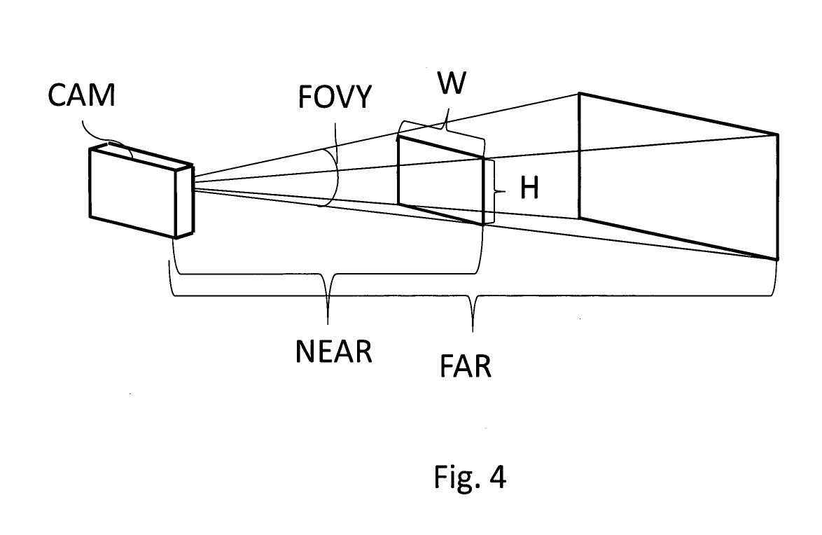

For rendering, the generated terrain is projected on a virtual projection plane defined by camera position parameters including camera position coordinates and camera orientation quaternions. This is depicted in FIG. 4, exemplarily. The projection is triggered by camera projection parameters such as field_of_view FOVY which is the field of view of camera, aspect_ratio which describes the ratio of window width W to window height H, near_plane which is the near clipping plane NEAR of camera CAM and far_plane which is the far clipping plane FAR of camera CAM.

For rendering a series of images from computer generated content, a virtual camera motion is defined by camera motion parameters such as a camera speed and a number of control points with control point coordinates which define a Non-Uniform Rational B-Spline (NURBS) curve on which camera motion occurs.

For practical terrain rendering, the synthesized terrain data is sampled by a series of height maps, also called clip maps. Each clip map can have the same grid size, but takes different spatial resolution as exemplarily depicted in FIG. 4. Clip map of level n-1 is the finest level, which sample the terrain data with the smallest spatial resolution, while clip map of level 0 is the coarsest level, which sample the terrain data with the largest spatial resolution, the spatial resolution of a coarser clip map is two times of its nearest finer sibling. The finer level clip maps are nested in the coarser level clip maps. Usage of clips maps for practical rendering of synthesized terrain is triggered by the number of levels of detail, the degree of spatial resolution at each level and said same grid size. A description of grid maps can be found in Frank Losasso, and Hugues Hoppe: “Geometry clipmaps: Terrain rendering using nested regular grids” Siggraph, 2004.

The current invention proposes a coding framework for encoding NV together with data which allows for execution of at least one of the steps involved in procedural computer graphics generation and rendering at decoder side.

Therefore, a new syntax is proposed. At a NVCG-level, said syntax comprises a CG_flag being set in case a subsequent bit stream portion comprises CG content and not being set in case a subsequent bit stream portion comprises NV content.

CG_flag is used to indicate the type of following bitstream: traditional video coding bitstream or computer graphics generated bit stream. This flag can be represented in a variety of ways. For example, the CG flag can be defined as a new type of NAL (Network Abstraction Layer) of H.264/AVC bitstream. Or, the CG flag can be defined as a new kind of start_code in MPEG-2 bitstream.

In the decoder side, first the CG_flag bit(s) are decoded. If the flag indicates that the following bitstream is encoded by procedural graphics method, then graphics decoding and rendering process is conducted. In an embodiment of the decoder, traditional video decoding process is conducted if the flag indicates that the following bitstream is encoded according a residual coding method.

For the CG content, in an exemplary embodiment the following additional syntax elements are proposed:

CG_category defines the category of CG content. The optional CG content can be: Terrain, Seawater, 3D Mesh Model, etc.

CG_duration_h, CG_duration_m, CG_duration_s, CG duration_ms defines the duration of CG content in hour, minute, second, and millisecond, respectively.

CG_duration=CG_duration_{—}h*60*60*1000+CG_duration_{—}m*60*1000+CG_duration_{—}s*1000+CG_duration_ms

CG_duration is recorded in the unit of millisecond.

terrain_coding_type indicate the terrain generation method used in reconstruction. The optional method can be RMF (Ridged Multi-Fractal), FBM (Fractal Brown Motion), or other methods.

permutation_table_size defines the size of permutation table, e.g., permutation_table_size=1024.

number_of_octave indicates the number of octave of Perlin Noise, e.g., number_of_octave=12.

octave_parameter_1, and octave_parameter_2 defines two parameters for terrain generation. octave_parameter1 defines H and octave_parameter2 defines lacunarity.

average_height gives the average height, i.e., offset of terrain in height.

hight_weight_gain is the local height value weight

base_frequency defines the basic frequency of octave of level 1.

number_of_LOD is the number of Level of Detail (LOD).

cell_size is the spatial resolution of one cell

grid_size is the size of grid in clip map

camera_trajectory_type, 0 means camera position and orientation is store in key frame, 1 means camera position and orientation is interpolated from Non-Uniform Rational B-Spline (NURBS) curve defined by control points

key_frame_time_ms, A key frame in animation is a drawing which defines the starting and ending points of any smooth transition. key_frame_time_ms defines when the corresponding key frame occurs

position_x, position_y, position_z is the position vector of camera, or control points of NURBS curve, according to the value of camera_trajectory_type

orientation_x, orientation_y, orientation_z orientation_w is the quaternion of the orientation of camera

navigation_speed is the moving speed of camera,

number_of_control_points is the number of control points of NURBS curve

The invention also allows for encoding values for one or more of the above parameters and using predefined values for the remaining parameters. That is, a variety of coding frameworks with corresponding encoding and decoding methods and devices is proposed the common feature of these coding frameworks being a first syntax element for differentiating bit stream portions related to natural video and bit stream portions related to procedural generation content and at least a second element related to the procedural generation of content and/or the rendering of procedural generated content.

In an exemplary embodiment, a video code of combined natural video content and computer generated procedural terrain content comprises bits to indicate the category of subsequent bitstream: traditional encoded video bitstream, or graphics terrain bitstream wherein if said bits indicate graphics terrain bitstream, the subsequent bitstream at least some of the following information:
a) Terrain video duration information
b) Terrain coding method information
c) Perlin noise related information, e.g. number of octave, terrain generation function parameters, permutation table size, average height, basic frequency of octave of level 1, and/or local height value weight.
d) Clipmap information for rendering, e.g. number of Level of Detail (LOD), spatial resolution of one cell and/or the size of grid in clip map.
e) Camera information for rendering, further including Camera projection parameters, camera position information, camera orientation information, camera trajectory information, and navigation speed.

The procedural computer graphics can be for used for rendering a first part of an image, e.g. the background or the sky, while the remainder of the image is rendered using natural video. In another exemplary embodiment, a sequence of images comprising entire images is procedurally generated using computers and correspondingly encoded wherein the sequence further comprises entire other images which are residual encoded. The sequence can also comprise images only partly rendered using procedural graphics content.

In the exemplary embodiments there is a focus on terrain as terrain is one of the most popular natural scenes which can be modeled by procedural technology very well. But, the invention is not limited thereto. Sky, water, plants as well as cities or crowds can be generated procedurally, also.

1. Method for decoding data for rendering at least one image using computer graphics, said method comprising decoding a portion of a bit stream, said portion comprising a syntax element and at least one parameter for a parameter based procedural computer graphics generation method for generating said computer graphics, said syntax element indicating that said portion further comprises said at least one parameter.

2. Method of claim 1, said method further comprising: decoding a different portion of said bit stream, said different portion comprising a further syntax element and coefficient information for determining an invertible transform of at least one pixel block to-be-used for rendering of the at least one image, said further syntax element indicating that said different portion further comprises said coefficient information.

3. Method for encoding data for rendering at least one image using computer graphics, said method comprising encoding, into a resultant portion of a bit stream, a syntax element and at least one parameter for a parameter based procedural computer graphics generation method for generating said computer graphics, said syntax element indicating that said portion further comprises said at least one parameter.

4. Method of claim 3 further comprising encoding, in a different portion of said resultant bit stream, a further syntax element and coefficient information for determining an invertible transform of at least one pixel block to-be-used for rendering said at least one image, said further syntax element indicating that said different portion further comprises said coefficient information.

5. Method of claim 3, wherein said computer graphics is used for rendering terrain in said at least one image and said at least one parameter is extracted from real terrain data.

6. Method of claim 2, wherein the computer graphics is for used for rendering a first part of the at least one image and the at least one pixel block is used for rendering a different second part of the at least one image.

7. Method of claim 6, wherein the at least one image comprises a first image and a different second image, said first part comprising said first image and said second part comprising said second image.

8. Method of claim 6, wherein the at least one image comprises a first image and a different second image, said first part comprising a portion of said first image and a portion of said second image and said second part comprising a remainder of said first image and a remainder of said second image.

9. Method according to claim 1, wherein the computer graphics is three-dimensional and the at least one parameter further comprises camera position information and camera orientation information allowing for determining a rendering plane onto which the computer graphics is projected.

10. Method of claim 9, wherein the at least one image comprises a sequence of images and the at least one parameter further comprises camera trajectory information and camera speed information allowing for determining a sequence of rendering planes onto which the computer graphics is projected for rendering the image sequence.

11. Method of claim 9, wherein the at least one parameter further comprises projection information comprising information regarding at least one of: a field of view, an aspect ratio, a near clipping plane and a far clipping plane.

12. Method of claim 1, wherein the at least one parameter specifies at least one of:
a category of computer graphics,
a duration of display of the at least one image,
an procedure indicator indicating a type of procedure to-be-used for procedural generation of the computer graphics, said type being either ridged multi-fractal or fractal Brown motion,
parameters for generating coherent noise,
a number of levels of detail,
a cell size and
a grid size.

13. Apparatus for performing the method of claim 1.

14. Storage medium carrying a bit stream resultant from the method of claim 3.
